(19) United States
(12) Patent Application Publication
(10) Pub. No.: US 2003/0177135 A1
(43) Pub. Date: Sep. 18, 2003

(54) Multi-user database for computer-based information

(75) Inventors: Stephen Lechowicz, North Adelaide (AU); Keith Bladon, Heathfield (AU)

Correspondence Address: Ladas & Parry, 26 West 61st Street, New York, NY, 10023, US

(73) Assignee: AXON INFORMATION TECHNOLOGY PTY LTD.

(21) Appl. No.: 10/412,072

(22) Filed: Apr. 11, 2003

Related U.S. Application Data
(63) Continuation of application No. PCT/AU01/00537, filed on May 11, 2001.

(30) Foreign Application Priority Data
Oct. 13, 2000 (AU) PR0765

(51) Int. Cl. G06F 7/00

(52) U.S. Cl. 707/100

(57) ABSTRACT

The invention relates to a multi-user database for computer-based information having the following features: (a) the computer-based information is stored as a plurality of data elements; (b) new information is imported into the database by importing a data file, with the data file being automatically structurally analysed and separated into one or more data data elements; (c) a plurality of user views of the computer-based information are provided, wherein a user view is a view of the subset of the computer-based information arranged in a structure suited to the requirements of a particular user or class of users; (d) amendments to the computer-based information are made either by editing the data elements directly or by exporting a selection of data elements as a data file, amending the data file, and re-importing the amended data file.

### FIELD OF THE INVENTION

This invention relates to a multi-user database for computer-based information. The invention relates particularly but not exclusively to a database where computer-based information is stored as a plurality of data elements. The invention also relates particularly but not exclusively to a database featuring a plurality of user views of the computer-based information wherein a user view is a view of a subset of the computer-based information arranged in a structure suited to the requirements of a particular user or class of users.

### BACKGROUND OF THE INVENTION

The management of business documents and other information is a time consuming and costly process for many companies. It typically requires a great deal of effort to manage such information efficiently. This effort is particularly great for large companies where there can be large amounts of documents with multiple people requiring access to a particular document. Smaller companies can also suffer similar problems through a lack of formal procedures.

Where people are working on a project together there is often a need to compile the work into a final report. The final task of compiling and organising the information into one cohesive document can be a time consuming task. This is particularly so for large projects such as audits where the amount of documentation can be extremely large. Typically, in instances such as these each user works on their part of the project and then contributes the part for final compilation into the report. Difficulties arise where there is sharing of information, as such information is typically only shared upon final compilation of the report.

Problems can occur where a document is utilised by more than one person within the business. For reasons of accuracy and consistency it is important to be confident that when a change is made it is available to all persons viewing the same version of the document. In an attempt to alleviate this problem many companies use a document management system. In these systems information concerning documents is typically stored in pre-determined fields within a database. In general, users are granted the ability to view and/or amend documents on the basis of security rights, but for each document a user has rights either to view the whole document or none of it. There is nothing in a typical document management system which caters for the user who is only interested in a particular part of documents relevant to his or her task, or to enable the owner of a document to identify users who reference a given section of a document and would be affected by a change to that section.

The object of the present invention is to overcome or alleviate one or more of the problems present in the prior art.

### SUMMARY OF THE INVENTION

According to one aspect of the present invention there is provided a multi-user database for computer-based information having the following features:

(a) the computer-based information is stored as a plurality of data elements;

(b) new information is imported into the database by importing a data file, with the data file being automatically structurally analysed and separated into one or more data elements;

(c) a plurality of user views of the computer-based information are provided, wherein a user view is a view of a subset of the computer-based information arranged in a structure suited to the requirements of a particular user or class of users.;

(d) amendments to the computer-based information are made either by editing the data elements directly or by exporting a selection of data elements as a data file, amending the data file, and re-importing the amended data file.

Preferably, the user view additionally includes a view of a user-defined hierarchical tree structure. The user view may also include a view of structural relationships between data elements in that user view. Groups of structural elements may be further grouped to provide additional levels to the tree structure. The various tree structures displayed to a user may contain data elements in different formats.

The computer-based information may be in any suitable file format. File formats which are suitable include word-processor, spread-sheet, image, sound and video file formats. Particularly suitable file formats include text, rich text, html, jpeg, mpeg, wav file, MS-Word, MS-Excel and Adobe Portable Data file formats. The computer-based information may also include any suitable combination of suitable file formats.

The data elements within the data file may be automatically detected by the invention. Alternatively, the data elements may be pre-defined before importation into the database. Each data file may include one or more data elements.

Preferably the database includes the facility for the user to modify the user view by grouping and/or arranging one or more parts of the computer-based information. The user view may be modified in any suitable manner. A particularly suitable manner for modifying the view is the utilisation of a “drag and drop” type modification where the user may click on a certain element to move and/or group each data element or group of data elements.

The database may be connected to a network accessible simultaneously to a plurality of users. Any suitable network may be used. Particularly suitable networks include a local area network, a wide area network, the Internet and analogous networks such as an intranet.

In a preferred form each user or class of users is allocated a level of authorisation to access and/or edit some or all of the data elements and/or the structural relationships defining one or more user views.

The database may monitor amendment to the computer-based information or part thereof and provide the user with information regarding that amendment. The type of information provided may include any suitable type of information regarding the amendment. Particularly suitable information includes the date and/or time of the amendment and who has made the amendment. The information provided to the user may also include an indication of the location on the database, the number of instances in which the amended data element appears in user views, and the identification of users who have one or more views which include the amended data element.

A user may also be provided with the facility to merge or split one or more data elements on the database. Additionally, a user or class of user may also be allocated a level of authorisation to merge or split one or more data elements.

As another preferred feature, one or more parts of the computer-based information may be recognised as status fields and made available for numerical and/or statistical,processing. Any suitable type of processing may be made available. The status fields may be treated collectively or singly for the purposes of viewing and analysis. The results of the statistical processing may be made available in any suitable form including through the display of graphs and tables. Each status field may provide any suitable type of information. A particularly suitable type of status field information is in the -form of numerical values. This status field information may also be in form of written ratings corresponding to a pre-defined ratings system.

In another preferred form one or more parts of the computer-based information are recognised as status fields and parts of the computer-based information are represented to the user by reference to one of a plurality of visual indicators with each visual indicator indicating a value of the status field. A visual indicator may be in any suitable form. Particularly suitable visual indicators include colours, shapes, images and symbols.

As another preferred feature, one or more parts of the computer-based information may be recognised as information fields and made available for entering and storing user comments or other information. This information maybe processed in any suitable manner and any suitable type of processing may be made available. The results of this processing may be made available in any suitable form including through the display and/or output of reports, graphs and tables. The results may also be available as a self contained document. Each information field may provide any suitable type of information. A particularly suitable type of information is in the form of user comments including images and hyperlinks to other supporting information such as video files. This information may also be in form of formal references to corrective actions or other required information.

In another preferred form the user may select a plurality of data elements to be exported from the database as a new data file. These data elements may be exported to form a new data file in any suitable format or combination of formats.

The database may consist of two or more physically separate databases . In this form the data elements may be stored in one of the physically separate databases. The user view can be composed of data elements stored at different physical locations. The physically separate databases can be located on the user's computer or on another computer accessible via network, Internet or some other suitable means. Any reference to a database in this document therefore includes singular and plural physical databases as described.

According to a second aspect of the invention, there is provided a method of managing computer-based information, including the following steps:

(a) categorising the computer-based information into a plurality of data elements, and storing the data elements in a database;

(b) adding to the computer-based information by importing into the database data files, with each data file being automatically structurally analysed and separated into one or more data elements;

(c) creating a plurality of user views of the computer-based information, wherein a user view is a view of a subset of the computer-based information arranged in a structure suited to the requirements of a particular user or class of users;

(d) editing the computer-based information either by editing one or more of the data elements directly or by exporting a selection of data elements as a data file, amending the data file, and re-importing the amended data file.

The method may further include the step of allowing a user to modify a user view by grouping and/or arranging structural relationships between data elements.

The method may include the further step of recognising one or more portions of the computer-based information as information fields and making the information fields available for reporting, numerical and/or statistical processing.

### BRIEF DESCRIPTION OF DRAWINGS

The invention will now be described in further detail by reference to the enclosed drawings which show example forms of the invention. It is to be understood that the particularity of the drawings does not supersede the generality of the preceding description of the invention.

FIG. 1 is a schematic diagram showing operation of the invention according to one embodiment.

FIG. 2 is an alternative schematic diagram showing operation of the invention according to an embodiment of the invention.

FIG. 3 is a screen display of a user view of an embodiment of the invention.

FIG. 4 is a screen display of a user view of a further embodiment of the invention.

FIG. 5 is a screen display of the user altered view of the information illustrated in FIG. 4.

FIG. 6 is a screen display of a further user altered view of the information illustrated in FIG. 4.

FIG. 7 is a screen display of one data element.

FIG. 8 is a display of the statistical information processed according to one embodiment of the invention.

FIG. 9 is a table containing sample information regarding a number of data elements.

FIG. 10 is a table showing the relationship between a number of data elements.

FIG. 11 is the user view of the data elements represented in the table contained in FIG. 10.

FIG. 12 is a screen display of the data elements according to a further embodiment of the invention.

### DETAILED DESCRIPTION

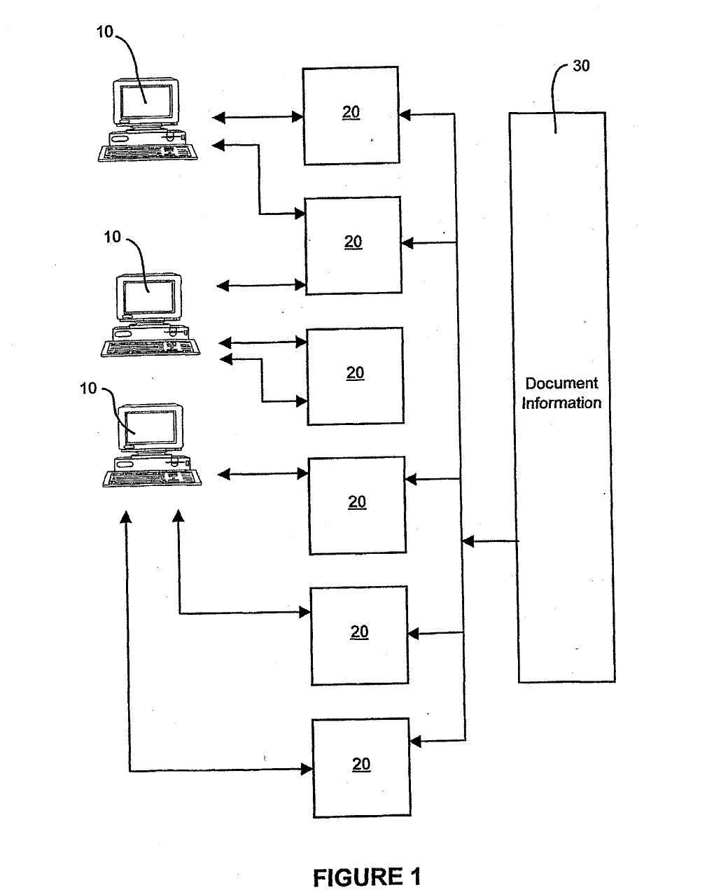

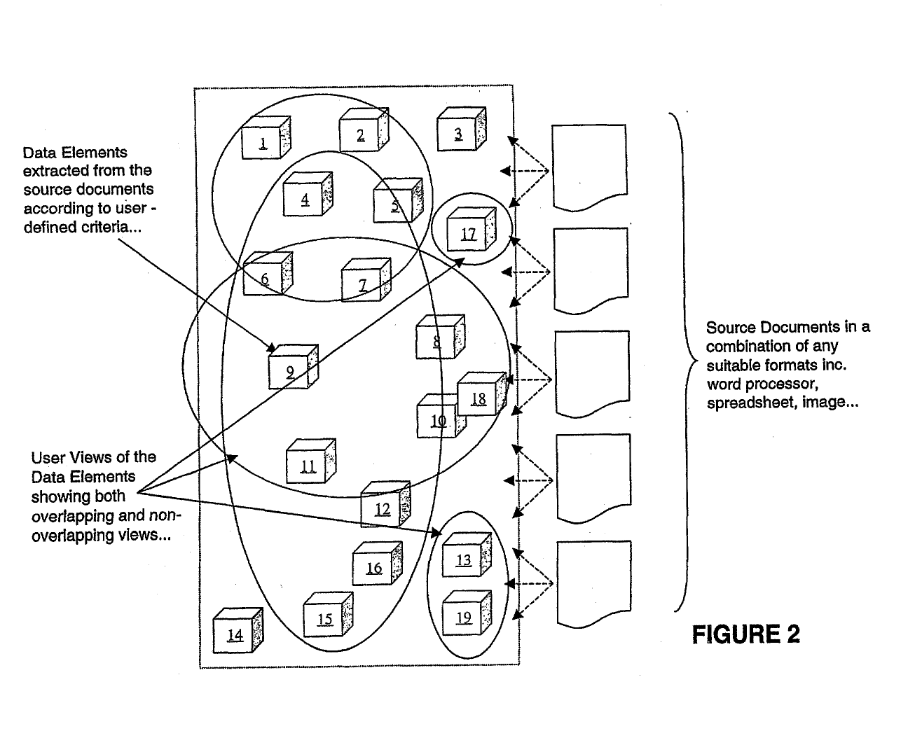

FIG. 1 is a schematic diagram illustrating an embodiment of the invention where the computer-based information, consisting of one or more data files is broken up into one or more data elements. These data elements and any structural relationships between data elements are stored in the database. Each user 10 is then provided with a customised view of the data elements arranged in a user-defined hierarchical structure 20 such that the user 10 has a view of the whole or part of the computer-based information 30 arranged according to the requirements of that user. This embodiment of the invention is also illustrated in FIG. 2. The source documents are imported onto the database and broken up into a number of data elements, each user can then customise their view of the data elements.

To import information into the database the user will select the data file to be imported. It is then necessary to identify each of the data elements within the document and the structural relationships between those elements and the database. The data elements and their structural relationships can be determined by the user. Alternatively they may be automatically determined by the invention. Where the data elements and relationships are determined automatically the invention will examine the data file and determine the data elements and their relationships using set parameters. Where the user wishes to pre-define the data elements and/or their relationships the user can browse the document and indicate to the invention where each of the data elements starts and/or finishes and what sort of structural relationship the data element has to other data elements. Alternatively, the user may select the data elements and/or structure by pre-defining his/her own global criteria to split the data file. For example when importing a Word document the user may determine that where bold 16-point text appears this signals the start of a new data element and that hierarchically these elements are at a higher level than data elements that begin with 14-point normal text.

Each of the data elements of the data file and the hierarchical relationships which constitute the document structure will then automatically be added to the database. The user can import as many data files as desired in any different type of format including text, rich text, jpeg, mpeg, wav, html, MS-Word, MS-Excel, MS-Powerpoint and Adobe PDF. These will all be analysed by the invention for data elements and structural relationships and automatically added to the database. This provides the user with a view of a number of structural elements arranged in a hierarchical tree structure.

Each view of the structural elements can be customised to the user's requirements. The user can modify the view of these elements by grouping them into “folders” or otherwise moving them around the hierarchical tree. This can be done by using the “drag & drop” type method where the user will click on a certain element or group of elements and drag them into place. This allows the user to customise his/her view without modifying the data elements stored in the database.

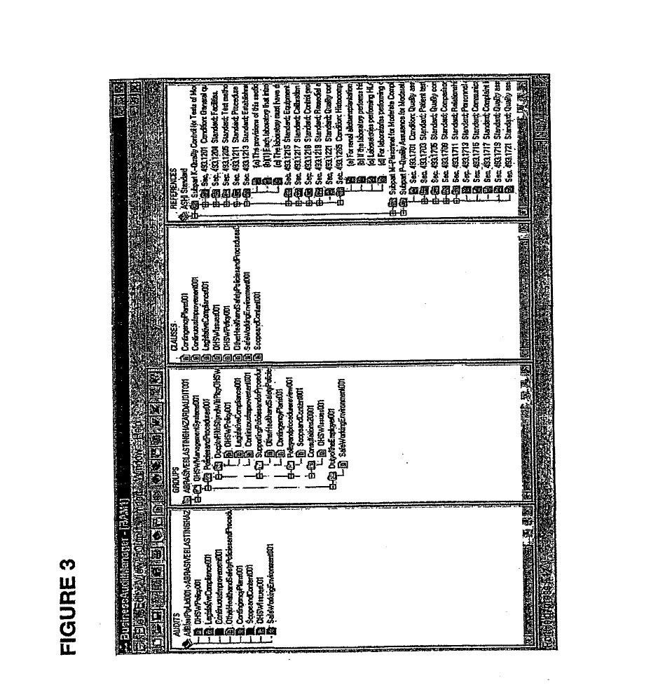

An example of the view represented to the user is illustrated in FIG. 3. The third column contains the data elements of the database available to that particular user. The user has arranged these data elements in a hierarchical tree type structure in column two. These data elements have been grouped further as shown in column one. The user may access each one of the data elements listed in column three by clicking on that element. It will then open the data element in the relevant format.

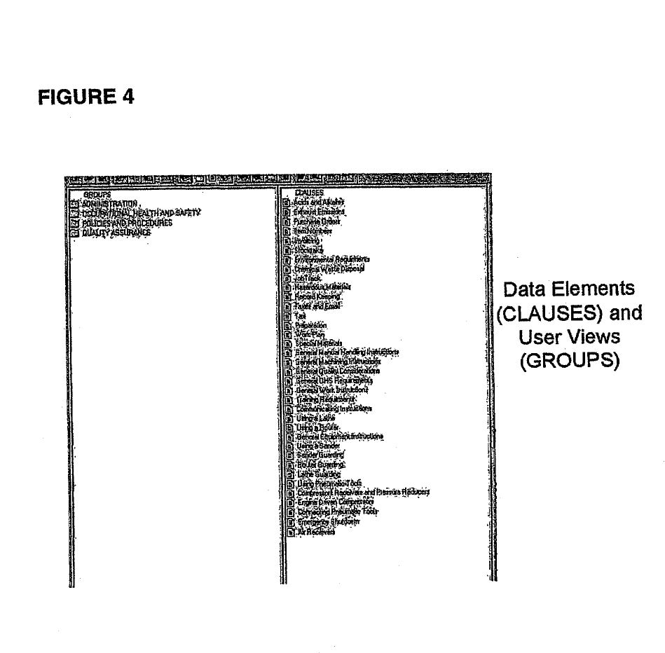

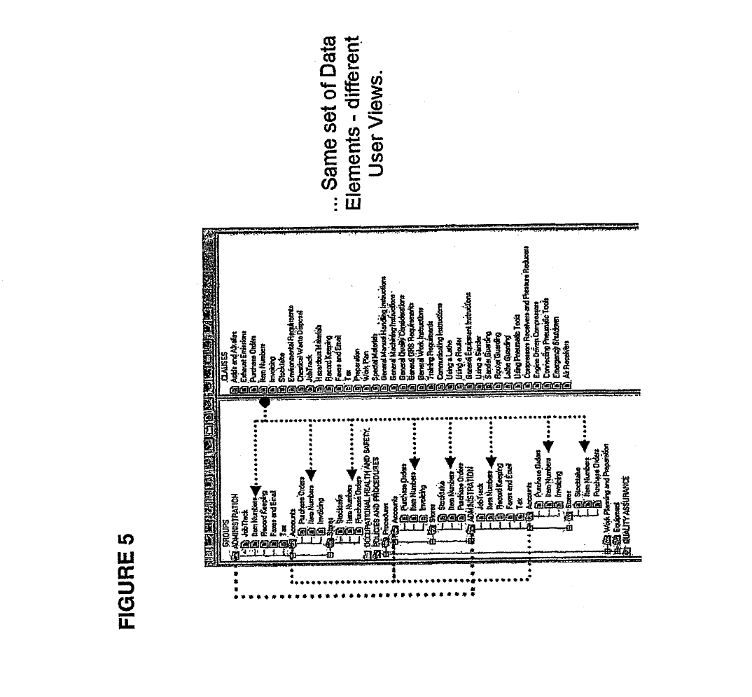

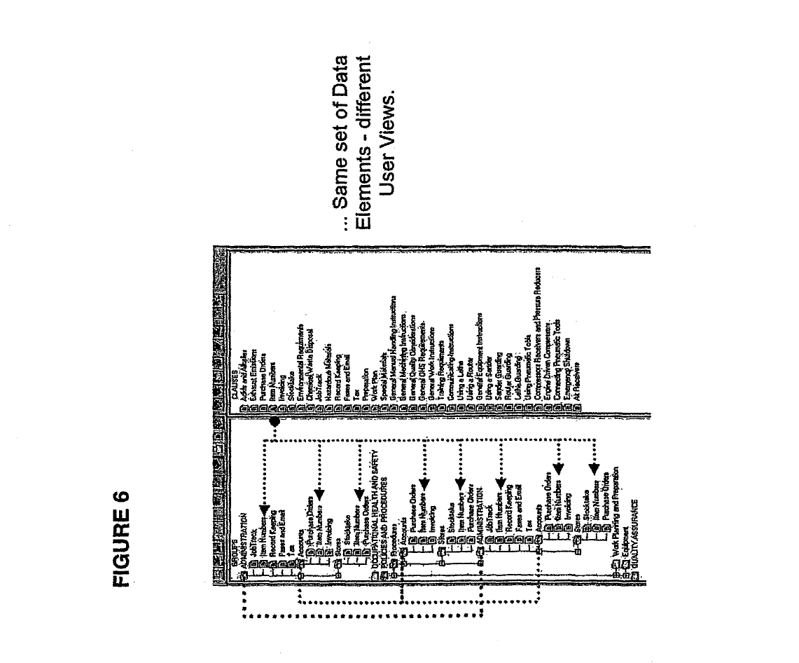

A further example of the view represented to the user is illustrated in FIG. 4. This illustrates a number of data elements in the right hand column. The data elements are grouped in folders. The user may then expand the folders to have a different view of the data elements. This is illustrated in FIG. 5. The user may further arrange and copy the view of the data elements to further customise their view. This is illustrated in FIG. 6. The copying of a data element creates an additional link to the data element without making an additional copy of the data element.

Typically each user will be allocated one or more identifiers which are used to store their particular view or views. These user identifiers can be stored within the database or in a separate external file. This identifier may include a level of authorisation which allows the user access to particular data elements. The database may also only allow specifically authorised users to modify specified data elements stored within the database.

In a preferred embodiment of the invention the database is located on a server connected to the Internet or Intranet. Appropriately authorised users can then import data files into the database splitting them into appropriate data elements with the appropriate relationship between each element. Each user can then access each of the data elements which they are authorised to access by making a connection to the network and appropriately identifying themselves to the database. A further level of security can be added which only allows authorised persons to edit specific data elements. A security feature may also be used to control which users have the ability to merge or split data elements on the database.

Where amendments are made the database preferably keeps track of information regarding each amendment. The type of information kept, and subsequently available to properly authorised users, includes the nature of the amendment, the user responsible for the amendment and the date and time of the amendment. Where an amendment is made the database also tracks that amendment and displays to the user information concerning the data elements, structural relationships and user views affected by the amendment.

Different users can define different views of the data elements. Amendments made to a data element are automatically propagated to each user whose view or views contain that data element. The database records the views that are affected by the amendment of a data element so that the effect of the amendment can be traced.

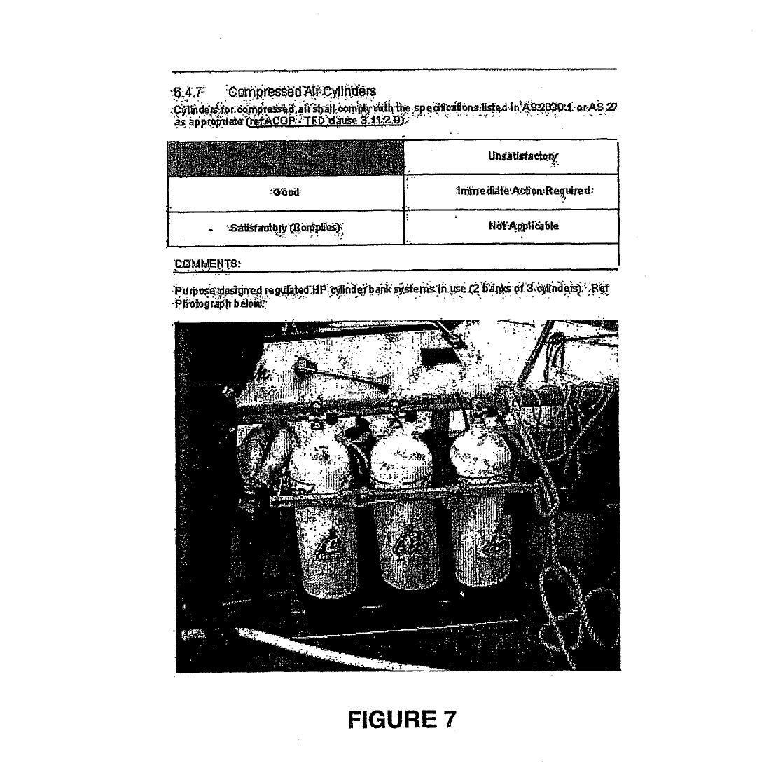

Each of the data elements may be allocated one or more status fields which can be used to give a rating to each of the elements. The information stored in each of the status fields may be some combination of numerical scores and textual ratings. A combination of numerical and textual ratings is termed a “rating scheme”. The ratings schemes may be either basic or extended. A basic ratings scheme provides for a positive or negative value to be attributed to each element. An extended ratings scheme provides that the element can be rated according to a more complex system which provides for more than two standards. For example, the user may rate a particular data element according to one of—Excellent, Very Good, Good, Satisfactory and Unsatisfactory. An example of a data element which contains an extended ratings scheme is shown in FIG. 7. Here the user can access the element and choose the standard of compliance. The choices in this example are Excellent, Good, Satisfactory (Complies), Unsatisfactory, Immediate Action Required and Not Applicable. The combination of textual and numerical ratings may be adjusted by the user to provide different weighting for different data elements.

The data element in FIG. 7 can be modified by entering a rating. This is done by double-clicking. In this case if the user double-clicks on Unsatisfactory the Excellent cell clears (from bright green) and the Unsatisfactory rated cell acquires the user defined colour code (yellow). Hyperlinks are also available. The user can enter these inside the COMMENTS section along with other text, images, tables, charts and other suitable information.

The status fields can be further processed by the invention singly or collectively according to the user-defined groupings as defined in the structural relationships between data elements. The analysis of ratings associated with a subset of data elements can be modified by grouping the data elements into various relationships.

The status fields can be further processed by the database in a numerical or statistical manner to give users statistics regarding the data elements. This statistical information can be presented using any combination of suitable formats including tables and graphs.

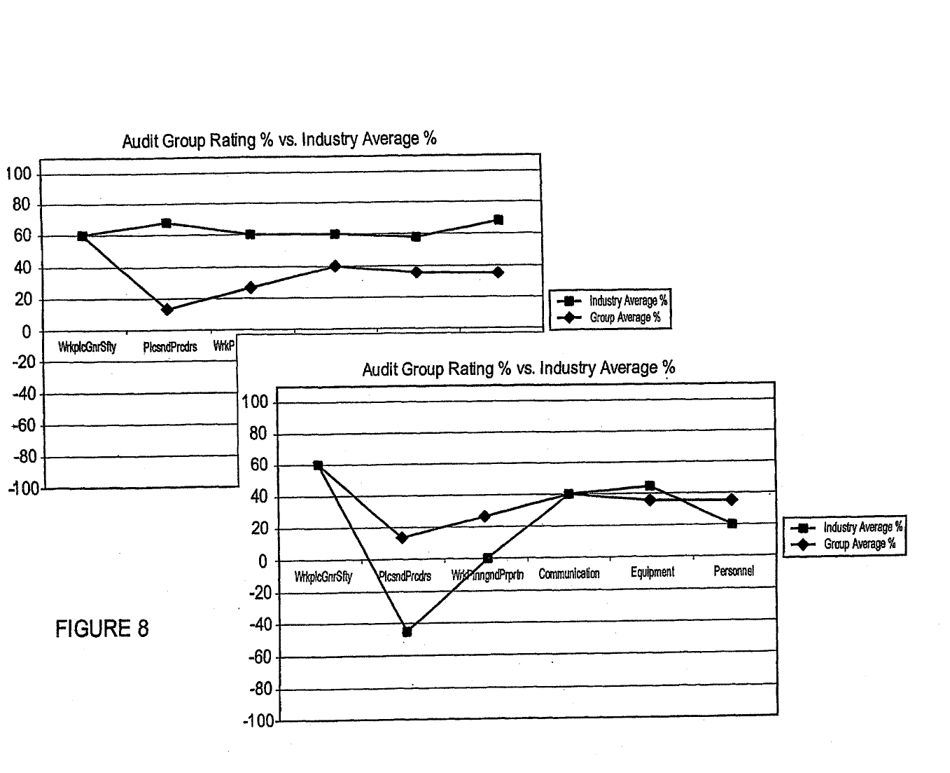

The ratings entered by the user in FIG. 7 have a point value which may be defined by the user (along with the color code). For example in the case of an audit using the invention these ratings can be imported into the database and associated with a specific Audit. When several Audits are based on the same or a similar data element structure they can be analysed collectively. An example of a graph produced by the database is illustrated in FIG. 8. The example above shows percentage rating for each main structural grouping of data elements in an audit. One line represents the results achieved by the subject of a particular Audit while another represents the ‘industry average’ from other similar audits selected for comparison. This facility can also be used to track trends over time.

The user may also be presented with another ratings type scheme in the form of a colour coding or other visual cue including shapes and/or images associated with the various data elements or groups of data elements. These can be visually coded using colour or otherwise by the database to indicate to a user a certain characteristic. For example during an audit a green colour for the data element may indicate that the content of that data element has been reviewed by a user and that it complies with their requirements. A red colour may mean that the content of the data element has been reviewed but does not comply. A yellow colour may mean than the data element has not yet been assigned a rating.

Each of the data elements may be allocated one or more information fields which can be used to add user comments or other type of supporting information. The information stored in each of these fields may be some combination of different formats including text and images. For example, the user may wish to provide a reader with information about the reasons for associating a particular rating with a particular data element. The user may also wish to provide supporting information in the form of a digital photograph. The user may also be required to enter information regarding corrective actions required as a result of an audit.

The information fields can be further processed by the invention singly or collectively according to the user-defined groupings as defined in the structural relationships between data elements. The analysis of such information associated with a subset of data elements can be modified by grouping the data elements into various relationships. For example a user may wish to see all document elements for which a corrective action was entered.

The information fields can be further processed by the database in a numerical or statistical manner to give users statistics regarding the data elements. This statistical information can be presented using any combination of suitable formats including tables and graphs.

The information fields can be further processed by the database to produce reports or presentations based on user defined criteria. These reports and presentations can be presented using any combination of suitable formats including text, images, tables, graphs and video.

When the data elements are not accessed through an interface associated with the database they may be viewed in the normal manner. That is, they may be viewed separately or as part of a collective data file similar to that which was originally imported into the database. When manipulation of the information has been completed the data file or data files can be distributed to other people who do not have access to the multi-user database of the present invention.

Where a user wishes to associate a number of particular data elements the user may select these elements to export them from the database as one single data file in a format or formats of the users choice.

For example where the invention is used to facilitate an audit the relevant information in the form of data files is imported into the database. Each of the users of the particular audit is allocated an authorisation to view and/or edit specific elements based on their function within the audit team. Users can then review the documentation as they conduct their audit, adding additional data elements as they deem necessary.

Some of the data elements may represent rating documents in the audit process which the auditor must fill out. An example of this is FIG. 7. After reviewing the subject matter contained in the document and inserting the appropriate rating the auditor can connect to the database to upload the document. In this instance the rating occurs according to the set criteria. Here the user has set the compliance rating as Excellent. The database can be accessed in this manner by a number of users who are auditing different items which correspond to different data elements or users who are auditing the same item/data element for different Audits. The database can be used to keep a continuous track of all the information as it is collected. Users can also make use of the status fields to determine relevant statistical information about the data elements. For example a user may be able to access the database and process the information to determine that only 50% of the data elements have been given compliance.

The invention can be used for a large number of purposes. It is particularly useful where multiple users need to store large amounts of reference or shared information. This makes the invention useful for a wide range of data management applications.

The invention utilises the cellular approach to information. This relies on information being stored in a number of cells or data elements. The particular information stored in each data element can be user defined, typically a data element will be the smallest entity in which information can be stored while maintaining the context of the information. This allows the user to arrange the information as required. A data element may consist of a graph, a sound, movie or section of a document. Each data element also contains descriptive information such as the owner, type of protection, type of data and date of last modification.

The data elements or cells are held in a structure termed a skeleton or frame. This enables the user to see the data elements arranged in a hierarchical tree format. The actual storage location of each data element is of no consequence. The data elements may be copied and manipulated by the user if required, this allows the user to customise their view. Where the user arranges their view of the data elements what is actually being changed is that users link to the data elements rather than the location or content of the element on the database.

The user may then construct one or more views of the data elements which match the users requirements. When editing the information the user may write to the data element altering its contents, this will propagate the altered data element through each users view so that when other users access this data element the altered information will appear to them.

This approach minimises the problems associated with storage of files in different areas. It also alleviates the requirement for multiple copies of files. The data elements can now be backed up and controlled in an efficient and secure manner. The invention may be overlayed on existing operating systems so that it will function with software currently available to the-user.

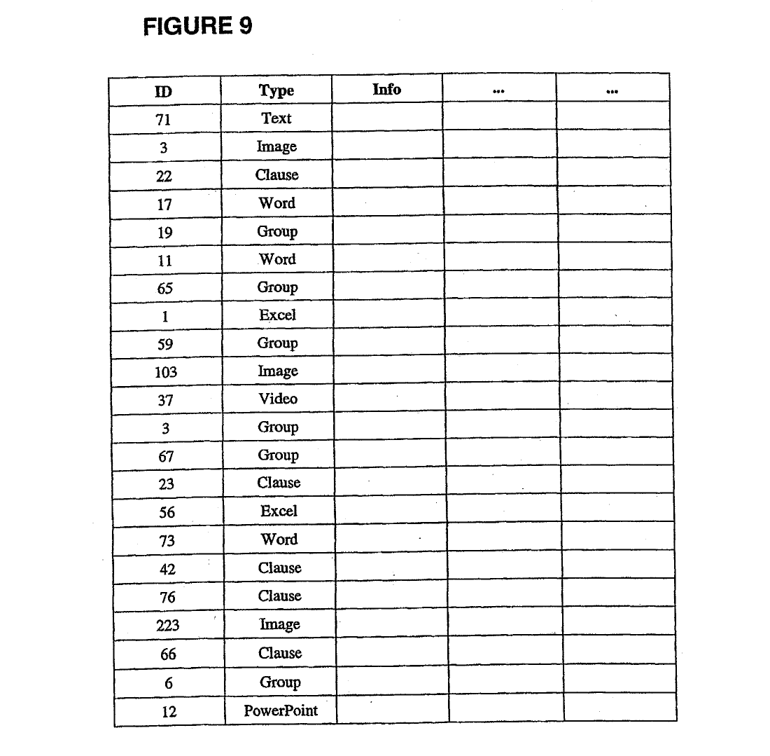

Information regarding each data element can be stored in a table. The information stored may include any suitable type of information. In particular it may include the type of file which the data element originated from. For example if a text file is divided into a number of data elements then each data element will be given an identification that it contains text type data. This format information is illustrated in FIG. 9. A user with the appropriate access may opt to convert a data element from one format to another. For example a user may wish to convert a data element from text to the company standard Word format to make that data element consistent with other company data.

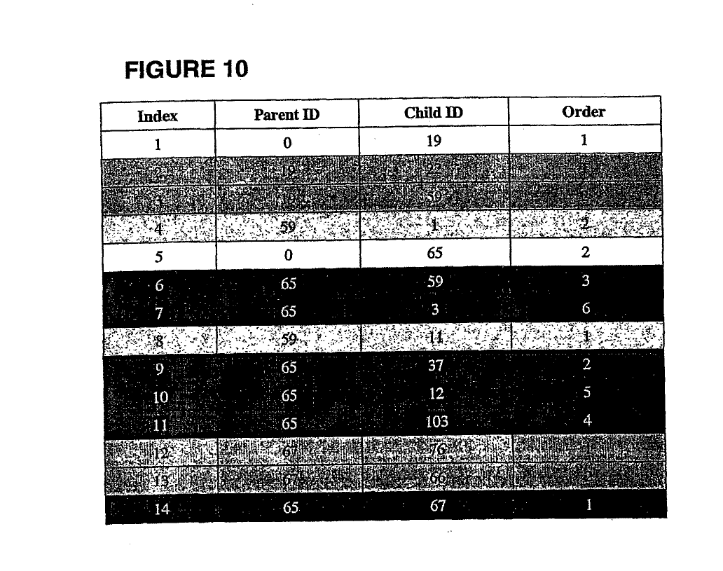

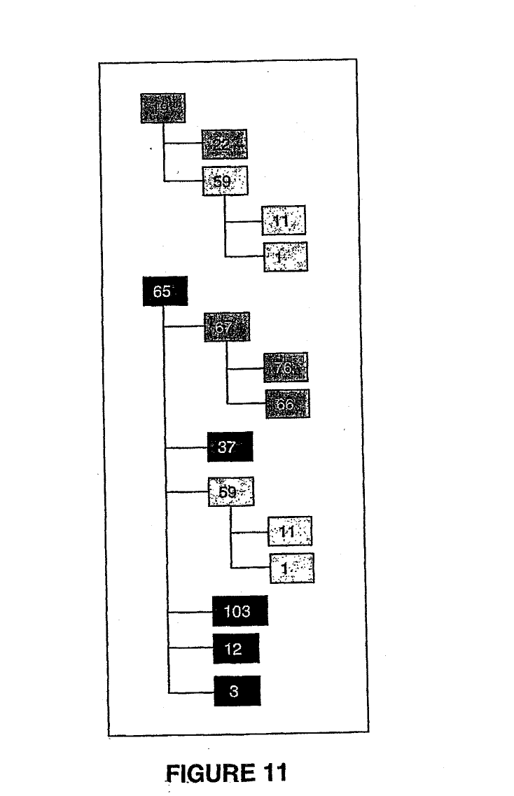

As the views of the data elements are altered by a particular user that view can be stored within a table. The table can then be used to duplicate the users view when they next log onto the database. A table which lists this relationship is illustrated in FIG. 10. Each data element is given a ParentID field, ChildID field and Order field to define its position within the hierarchical tree. The Order dictates the level at which the data element will appear to the user, 1 being the highest in this example. The ParentID and ChildID gives the relationship between the specific data elements. A graphical representation of the data elements represented in the table in FIG. 10 is shown in FIG. 11. This shows the hierarchical tree structure represented by the table.

The present invention represents documents in a tree structure similar to Microsoft Explorer. It can integrate highly developed applications such as Microsoft Word to perform word-processing, Excel for graphing and Access for storage. Document tree structures can combine different document sections in different ways to provide a ‘view’ that is customised to a particular facet of a business while retaining the ability to propagate updates throughout all views simultaneously. For example, a business that involves manual handling will have Work Instruction documents as well as documents for Occupational Health & Safety (OH&S), Quality Control and many others. These documents, while different, will share many of the same ‘clauses’ (for example both Work Instructions and OH&S would probably share clauses such as “Maximum weight that can be lifted without mechanical assistance . . . ”). The invention may store these clauses or data elements separately and link them into different ‘trees’ so that someone with a particular business role can access the information they need while remaining consistent with other people and other roles.

One embodiment of the invention utilises common interfaces to minimise the need for training that is often associated with incorporating a new software tool into a business. In effect it avoids the requirement for people to develop a new expertise as a prerequisite for making use of the tool.

This invention can be used for audits. Building an audit is similar to putting files in a directory tree structure in Explorer. Clauses (which can contain hyperlinks to background material) are combined into Groups that are, in turn, used to make up an Audit. The building blocks and their groupings may be entered manually or imported directly from a Word document with a heading structure that is translated into the tree structure representation by the invention.

The invention allows for an interface directly to Microsoft Word or other word processing software to handle all word processing functions such as output of audit documents. It can also import Clauses, Reference material, Groups and Audits written as Word documents. All Word features used are standard—they can be used within any Word document and are described in the standard Word help. Once an audit is output as a Word document it is stand-alone.

Active Rating buttons may also part of documents associated with the invention. An example of this is FIG. 7. These are used to give a rating of compliance for each Clause by double-clicking with the mouse directly on the document in Word. During creation or modification of an audit the user can customise the rating scheme that corresponds to a specific clause. In one case a clause may best be rated simply as ‘Complies, Does Not Comply or Not Applicable’ whereas in another case an extended rating scheme may be used. The ‘points’ associated with each rating may also be specified by the user to give different weighting to different clauses. Comment and Corrective Action fields are also associated with each Clause. The auditor can enter any explanatory text, digital photographs and/or hyperlinks to other files into these areas and save them with the other results. Thus the Word document is the direct data entry mechanism. This improves on the standard approach of breaking data entry into separate specialised forms.

Once the data is entered into the document it can be uploaded into the database by clicking Retrieve Results and selecting the file. The program can then output the results to Excel to be displayed in graphical form. As with the Word documents, the Excel file produced is standard and can be worked with independent of the invention. It is worth noting that the use of the document as a data entry mechanism could allow an auditor to input the results directly via a notebook or palm-type computer or even voice recognition software rather than going through a stage of transcribing from paper to computer.

The present invention may be regarded as a cellular approach to information targeted at the general computer user. It is based on a higher context; that being:

Information is stored in user-defined data elements. Typically a data element would be the smallest set of information having some independent meaning such as a clause or chapter rather than a letter or word. Data elements can contain graphs, sounds, videos (or scenes from videos), sections of a document and/or any other suitable format or combination of formats.

Each data element carries an amount of descriptive information similar to the existing traditional “file” (owner, protection, type of data, dates etc)

Data elements are linked in structures presented to the user as hierarchical trees. The actual storage location of the data element is of no consequence. The structure can be copied and manipulated in a similar way as the current Explorer interface, except that the objects being moved and manipulated are not the actual data elements but rather links to the data elements.

A user can construct one or more views of the business or subject using data elements relevant to them. Some of the cells in their view may be read/write/arrange while other may be read/arrange-only. The views that include a data element all look at the same information and consequently any changes to that information are seen in all these views. Conversely, the users effected by a change can be traced. This provides a workable method of document control and a simple, scalable mechanism for change management.

One embodiment of the invention allows data to flow between cells and views would update in real-time thus providing real-time control system functionality. This would also service the basic business concept that the current software products do not—the PROCESS.

Because of the removal of scattered storage and multiple copies of “files” (which were created using the existing art to make slightly different views) the Cells can now be backed-up and controlled in a much more efficient and secure manner.

Most businesses use a number of specialized business software applications. For example, Word for reports, manuals and business process documents, Excel spreadsheets for Quality or OH&S auditing, 4TQ for process modelling and Adobe Acrobat for reference document control. An embodiment of the present invention provides a framework and user interface that stores business records as data objects within a database instead of word processor files, spread-sheet files, images and the like.

The features of one embodiment of the invention include:

1. The user interface is based on an Explorer style tree-view to represent structured documents and their building blocks or data elements. This, plus the integration of common office applications, makes it familiar to most computer users.

2. Data elements (such as clauses from policies and work instructions) are securely stored in one place and used as sources arranged and linked to suit the particular user.

3. The data entry method is up to the user. (for example, through spread-sheet and/or word processor software) There are no traditional “forms”. Data elements (and optionally their structural relationships) can be imported direct from any document having consistent structure (eg section headings, PowerPoint slides etc).

4. Users may assemble ‘views’ that suit their requirements in a similar way to organising a directory structure from the files on a hard disk—Cut/Copy & Paste or Drag & Drop.

5. When a common building block is altered then the ‘views’ are automatically updated. The effects of a change can then be traced throughout the business.

The invention may be used as a qualitative measurement of compliance with some set of criteria. So this application lends itself to various fields such as OH&S Audits, Environmental Compliance, Quality Control, multiple choice tests (ie psychological profiles, academic exams, customer demographics, human resources etc). In the area of OH&S it gives the regulatory body the ability to compare consistent results across and industry or over time. The invention can be used by industry to perform self-audits, the results of which can be emailed to the regulatory body.

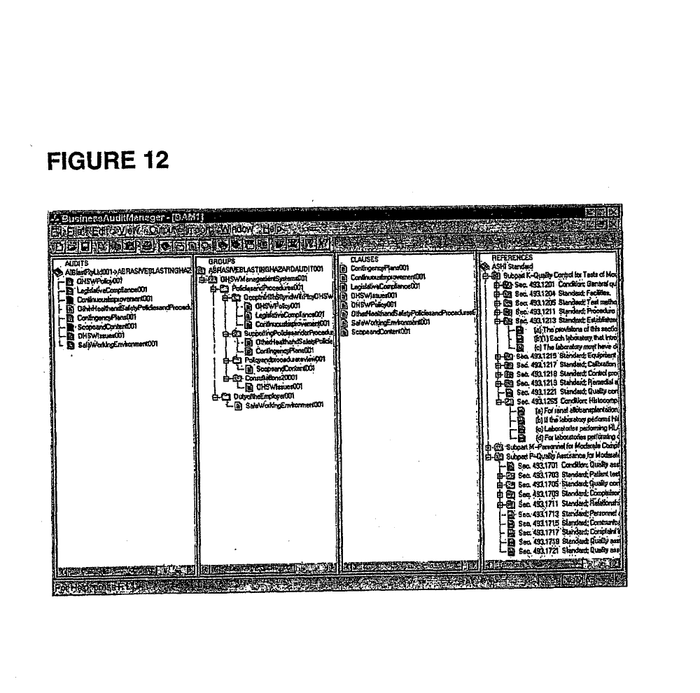

Application on this invention to an Audit is illustrated in FIG. 12. The AUDITS window (far left) contains the colour coded results of an audit based on the ABRASIVEBLASTINGHAZARDAUDIT001 group shown in the GROUPS window. Note that the clauses from the Group are reproduced without the structure under the Audit. The user has the option of switching between an Audit view with or without the structure being displayed.

The GROUPS window shows a single example of a view constructed from the building blocks (or data elements) shown in the CLAUSES window. The structure shown is made up of virtual links that allow multiple views to look at the same Clauses (ie overlapping views). This means that an update to a Clause will be automatically reflected in the views that included that Clause. A user with sufficient access can Cut & Paste or Drag & Drop to create or modify views.

By double-clicking on the Clauses (data elements) in the CLAUSES window a user (with the correct access rights) can edit or view using the native application for that data element. The Clauses in this example are all from a Word document so they would be edited in Word however other building blocks could be taken from Excel, PowerPoint or another format such as mpeg.

The REFERENCES window (far right column illustrated in FIG. 12) shows data elements imported from a scanned document using user-defined structure in the form of fonts and prefixes. Any file can be separated into its component data elements. The user can control the break down of data elements the rule of thumb being ‘a data element is the smallest subsection of a file that has meaning on its own’.

The invention provides for individual views into the business. These views can be structured to be used in any suitable way. Example applications include where

An individual in a production area has a set of work instructions, a number of quality procedures, a selection of policies and procedures that are relevant, a self-audit process, a common corrective action system etc.

An individual responsible for managing the Workplace Safety has a view encompassing the OH&S requirements for that business plus a corrective action system.

A management view requires a high-level selection of key records from processes or individuals. For example, the results of an Occupational Health and Safety audit as a graph with average prior audit performance as a benchmark.

It is to be understood that various additions, alterations and/or modifications may be made to the parts previously described without departing from the ambit of the invention.

The claims defining the invention are as follows:

1. A multi-user database for computer-based information having the following features:
(a) the computer-based information is stored as a plurality of data elements;
(b) new information is imported into the database by importing a data file, with the data file being automatically structurally analysed and separated into one or more data elements;
(c) a plurality of user views of the computer-based information are provided, wherein a user view is a view of a subset of the computer-based information arranged in a structure suited to the requirements of a particular user or class of users;
(d) amendments to the computer-based information are made either by editing the data elements directly or by exporting a selection of data elements as a data file, amending the data file, and re-importing the amended data file.

2. A database according to claim 1 wherein the user view additionally includes a view of a user-defined hierarchical tree structure, showing structural relationships between data elements in that user view.

3. A database according to claim 1 or claim 2 including a facility for a user to modify the user view by grouping and/or arranging one or more parts of the computer-based information.

4. A database according to any one of claims 1 to 3 wherein the database is connected to a network and accessible simultaneously to a plurality of users over the network.

5. A database according to any one of claims 1 to 4 wherein each user or class of users is allocated a level of authorisation to access and/or edit some or all of the data elements and/or the structural relationships defining one or more user views.

6. A database according to any one of claims 1 to 5 wherein the database monitors amendment to the computer-based information or part thereof and provides the user with information regarding that amendment.

7. A database according to claim 6 wherein the information provided to the user includes a version number.

8. A database according to any one of claims 1 to 7 wherein data elements may be merged or split.

9. A database according to claim 8 wherein a user or class of users is allocated a level of authorisation to merge or split data elements.

10. A database according to any one of claims 1 to 9 wherein one or more portions of the computer-based information are recognised as status fields and made available for reporting, numerical and/or statistical processing.

11. A database according to any one of claims 1 to 10 wherein one or more portions of the computer-based information are recognised as status fields and parts of the computer-based information are represented to the user by reference to one of a plurality of visual indicators with each visual indicator indicating a value of the status field.

12. A database according to any one of claims 1 to 11 wherein one or more portions of the computer-based information are recognised as information fields and made available for reporting, numerical and/or statistical processing.

13. A database according to any one of claims 1 to 12 wherein a user may select a plurality of data elements to be exported from the database as a new data file.

14. A database according to any one of claims 1 to 13 wherein the database consists of two or more physically separate databases.

15. A method of managing computer-based information, including the following steps:
(a) categorising the computer-based information into a plurality of data elements, and storing the data elements in a database;
(b) adding to the computer-based information by importing into the database data files, with each data file being automatically structurally analysed and separated into one or more data elements;
(c) creating a plurality of user views of the computer-based information, wherein a user view is a view of a subset of the computer-based information arranged in a structure suited to the requirements of a particular user or class of users;
(d) editing the computer-based information either by editing one or more of the data elements directly or by exporting a selection of data elements as a data file, amending the data file, and re-importing the amended data file.

16. A method according to claim 15 further including the step of allowing a user to modify a user view by grouping and/or arranging structural relationships between data elements.

17. A method according to claim 15 or claim 16 including the further step of recognising one or more portions of the computer-based information as information fields and making the information fields available for reporting, numerical and/or statistical processing.
